(19) United States
(12) Patent Application Publication
(10) Pub. No.: US 2025/0327491 A1
(43) Pub. Date: Oct. 23, 2025

(54) Drive Shaft Assembly with Spline Coupling

(71) Applicant: DeltaHawk Engines, Inc., Racine, WI (US)

(72) Inventor: David Keith Gill, Ortonville, MI (US)

(21) Appl. No.: 19/184,800

(22) Filed: Apr. 21, 2025

Related U.S. Application Data
(60) Provisional application No. 63/637,150, filed on Apr. 22, 2024.

(51) Int. Cl. F16D 7/04; F02B 39/04

(52) U.S. Cl. CPC F16D 7/044; F02B 39/04; F16D 2200/0021

(57) ABSTRACT

A drive shaft assembly for a supercharger is provided. The drive shaft assembly includes a shaft extending along a longitudinal axis, a spline coupling mounted on the shaft, and a spring mounted on the shaft adjacent to the spline coupling. The spline coupling includes a first face spline with first teeth and a second face spline with second teeth which are configured to engage with the first teeth. The first face spline and the second face spline are biased into engagement by the spring. When a rotational load applied to the first face spline is sufficiently high, the first face spline disengages from the second face spline such that the first face spline and second face spline can rotate at different rates.

### CROSS-REFERENCE TO RELATED PATENT APPLICATION

The present application claims the benefit of and priority to U.S. Provisional Application No. 63/637,150 filed on Apr. 22, 2024, which is incorporated herein by reference in its entirety.

### BACKGROUND OF THE INVENTION

The present invention relates generally to the field of pump devices with drive shafts. The present invention relates specifically to a drive shaft assembly with a spline coupling for a supercharger.

### SUMMARY OF THE INVENTION

One embodiment of the invention relates to a drive shaft assembly for a supercharger. The drive shaft assembly includes a shaft, a first spline coupling, a second spline coupling, and a spring. The shaft is centered on and extends along a longitudinal axis. The shaft has a first end and a second end opposite the first end along the longitudinal axis. The first spline coupling is mounted on the shaft and has a front surface with a plurality of first teeth. The plurality of first teeth extends in a direction away from the front surface and away from the second end of the shaft. The second spline coupling is mounted on the shaft and configured to slidably engage with the first spline coupling. The second spline coupling includes a back surface with a plurality of second teeth extending in a direction away from the back surface, away from the first end of the shaft, and towards the plurality of first teeth. The plurality of second teeth is configured to slidably engage the plurality of first teeth. The spring is mounted on the shaft adjacent to the first spline coupling and exerts a spring force against the first spline coupling that biases the first spline coupling into engagement with the second spline coupling. The spring has a predetermined spring constant. A contact radius is defined by the distance between the longitudinal axis and an outer edge of the front surface of the first spline coupling. The spring constant of the spring is selected based on the contact radius. When the first spline coupling and the second spline coupling are engaged, each first tooth in the plurality of first teeth is engaged with a corresponding second tooth in the plurality of second teeth. When a rotational load applied to the first spline coupling exceeds a frictional force defined between the plurality of first teeth and the plurality of second teeth, then the interface between the plurality of first teeth and the plurality of second teeth converts the rotational load into a linear load along the longitudinal axis. The linear load compresses the spring which allows the first spline coupling to slidably disengage from the second spline coupling and each first tooth to slidably disengage from its corresponding second tooth.

Another embodiment of the invention relates to a drive shaft assembly for a supercharger. The drive shaft assembly includes a shaft, a spline coupling mounted on the shaft, and a spring mounted on the shaft. The shaft is centered on and extends along a longitudinal axis. The shaft includes a first end and a second end opposite the first end along the longitudinal axis. The spline coupling includes a first face spline and a second face spline. The first face spline has a front surface with a plurality of first teeth extending in a direction away from the front surface and away from the second end of the shaft. The second face spline is configured to engage with the first face spline and includes a back surface with a plurality of second teeth extending from the back surface. The plurality of second teeth extends in a direction away from the back surface, away from the first end of the shaft, and towards the plurality of first teeth. The second teeth are configured to slidably engage with the first teeth. Each first tooth has a top surface spaced a distance from the front surface. Each first tooth also has an outer surface extending between the front surface and the top surface. The outer surface defining a plane that radially extends away from the longitudinal axis. The outer surface defines a contact angle. The contact angle is measured between a plane defined by the front surface and the outer surface. The spring exerts a force against the spline coupling and biases the first face spline into engagement with the second face spline. The spring has a spring rate. The spring rate required to maintain engagement between the first face spline and the second face spline is selected based on the contact angle. When the first face spline and second face spline are engaged, each first tooth in the plurality of first teeth is engaged with a corresponding second tooth the plurality of second teeth. When a rotational load is applied to the first face spline that exceeds a frictional force defined between the plurality of first teeth and the plurality of second teeth, then the interface between the plurality of first teeth and the plurality of second teeth biases the first spline coupling and second spline coupling apart from each other, which compresses the spring. When the spring is compressed, the second teeth can slidably disengage from the first teeth.

Another embodiment of the invention relates to a drive shaft assembly for a super charger with a shaft, a first spline coupling, a second spline coupling configured to engage with the first spline coupling, and a spring. The shaft extends along and is centered on a longitudinal axis. The shaft has a first end and a second end opposite the first end along the longitudinal axis. The first spline coupling is mounted on the shaft and includes a front surface with a plurality of first teeth. The plurality of first teeth extends from the front surface away from the second end of the shaft in a direction substantially parallel to the longitudinal axis. The second spline coupling is mounted on the shaft and includes a back surface with a plurality of second teeth. The plurality of second teeth extends from the back surface, away from the first end of the shaft, and towards the first teeth in a direction substantially parallel to the longitudinal axis. The spring is mounted on the shaft and exerts a force against the first spline coupling such that it biases the first spline coupling into engagement with the second spline coupling. The spring has a spring load. When a rotational load is applied to the first spline coupling and the first spline coupling and second spline coupling are engaged. When engaged, the interface between the first plurality of teeth and the second plurality of teeth transmits the rotational load from the first spline coupling to the second spline coupling such that the first spline coupling to the second spline coupling rotate around the longitudinal axis at the same rate. When the rotational load is sufficiently high, the interface between the plurality of first teeth and plurality of second teeth biases the first spline coupling and second spline coupling apart from each other, which compresses the spring. When the spring is compressed, the plurality of first teeth slidably disengage from the plurality of second teeth such that the first spline coupling and the second spline coupling are able to rotate around the longitudinal axis at different rates.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain the principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a second end of a supercharger with a transparent casing, according to an exemplary embodiment;

FIG. 2 is a perspective view of the drive pully, drive shaft assembly, phasing gear. and rotors of the supercharger of FIG. 1, according to an exemplary embodiment;

FIG. 3 is a detailed view of the drive shaft assembly and phasing gear of FIG. 2, according to an exemplary embodiment;

FIG. 4 is a rear perspective view of a drive shaft assembly with first face spline engaged with a second face spline of FIG. 1, according to an exemplary embodiment;

FIG. 5 is a side view of the drive shaft assembly of FIG. 4, according to an exemplary embodiment;

FIG. 6 is a rear perspective view of the drive shaft assembly of FIG. 4 with the first face spline disengaged from the second face spline, according to an exemplary embodiment;

FIG. 7 is a rear perspective view of the drive shaft assembly of FIG. 4 with the first face spline disengaged from the second face spline, according to an exemplary embodiment;

FIG. 8 is an exploded view of the drive shaft assembly of FIG. 4, according to an exemplary embodiment;

FIG. 9 is a detailed view of the first face spline of FIG. 4, according to an exemplary embodiment;

FIG. 10 is a detailed side view of a first tooth of FIG. 9, according to an exemplary embodiment;

FIG. 11 is a detailed view of the second face spline of FIG. 4, according to an exemplary embodiment;

FIG. 12 is a detailed side view of a second tooth of FIG. 11, according to an exemplary embodiment;

FIG. 13 is a cross-sectional view of the drive shaft assembly of FIG. 5, according to an exemplary embodiment; and

FIG. 14 is a detailed diagram view of the drive shaft assembly of FIG. 4 when the first face spline is engaged with the second face spline, according to an exemplary embodiment.

### DETAILED DESCRIPTION

Referring generally to the figures, various embodiments of a drive shaft assembly for a pump device is shown. Applicant believes that the drive shaft assemblies discussed herein assist in maintaining the balance of shaft loading between the driven section of the shaft and drive section of the shaft within a pump device. Specifically, the drive shaft assemblies discussed herein assist with reducing the load applied to the driven section of the drive shaft assembly and may be used to provide a temporary disconnection between the drive section and driven section of the shaft, when required.

Specifically, the drive shaft assemblies herein are for use with a supercharger. Superchargers function as air compressors and are used to increase the efficiency of an engine, such as an internal combustion engine, by pumping more air into the combustion chamber (which may be referred to as forced air induction). In high altitude situations, where air has a low-pressure density, forced air induction is used to provide higher-pressure air to the engine. A supercharger may be mechanically operated by the engine through a belt or chain drive connected to the engine's crankshaft. The belt is then connected to a drive pulley that rotates the drive shaft assembly of the supercharger and powers the supercharger. However, foreign objects, thermal expansion or contraction, and other conditions may result in a greater-than-normal load being applied to the drive shaft assembly which may cause the driven section of the shaft and the drive section of the shaft to experience different loads, which, in turn, may interfere with the typical operation of the supercharger.

Applicant has developed various drive shaft assemblies for a supercharger that are believed to provide various advantages. Specifically, the drive shaft assemblies discussed herein include a first spline coupling, a second spline coupling, and a spring. The first spline coupling includes a plurality of first teeth, and the second spline coupling includes a plurality of second teeth configured to engage the first teeth. The spring biases the first spline coupling into engagement with the second spline coupling. When a rotational load (or torque) applied to the first spline coupling exceeds the frictional force between the plurality of first teeth and the plurality of section teeth, then the interface between the plurality of first teeth and the plurality of section teeth converts the rotational load into a linear load along the longitudinal axis, which compresses the spring and disengages the first spline coupling from the second spline coupling such that the first face spline and second face spline are able to rotate at different rates. As such, Applicant believes that the drive shaft assemblies discussed herein reduce the load applied to the drive shaft assembly, when the load is greater than normal (i.e., the expected rotational load during standard operation of the engine). Additionally, Applicant believes that the drive shaft assemblies reduce the transmission of a greater-than-normal load to the rest of the supercharger, and, consequently, the rest of the engine.

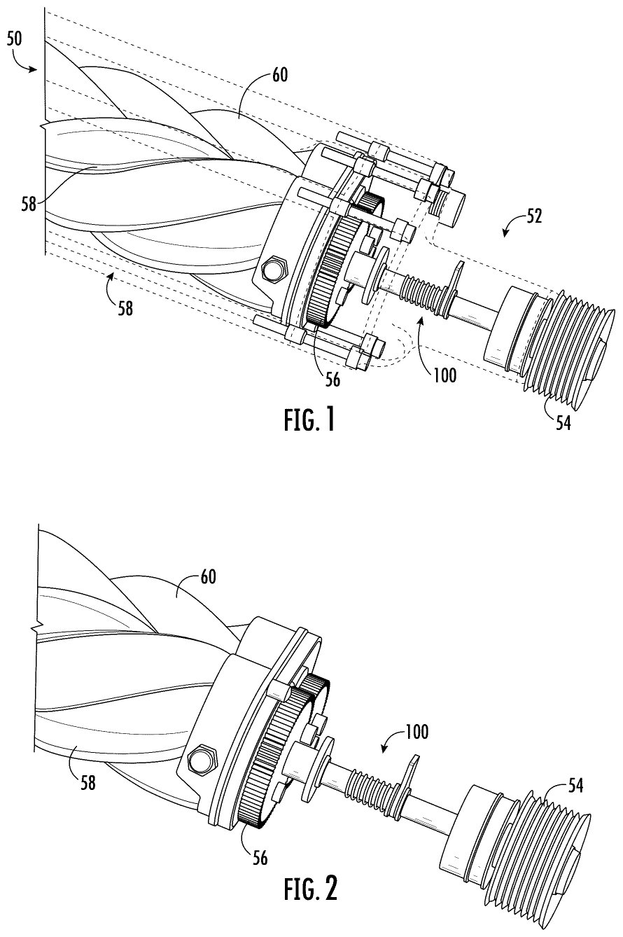

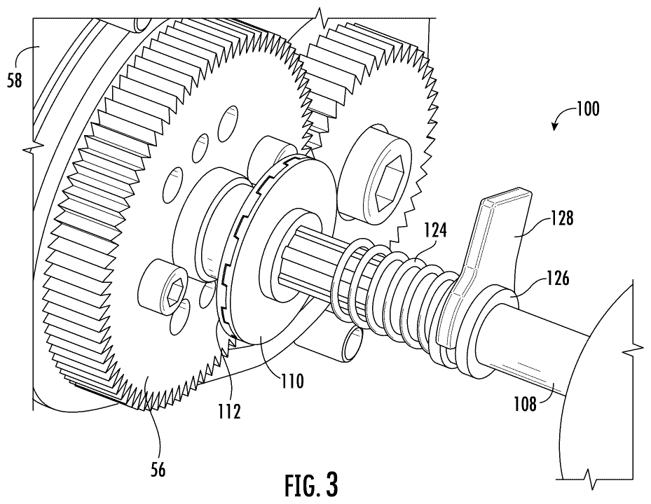

Referring to FIGS. 1-3, a supercharger 50 is shown according to an exemplary embodiment. As shown, supercharger 50 is a twin-screw-type supercharger. Supercharger 50 has a casing 51 with a first end and a second end 52 opposite the first end. Supercharger 50 includes a drive pulley 54 mounted on second end 52, a drive shaft assembly 100 coupled to drive pulley 54, a phasing gear 56 coupled to drive shaft assembly 100, and rotors 58, 60 coupled to phasing gear 56.

Supercharger 50 is mechanically operated by an engine through a belt or chain drive connected to the engine's crankshaft. The belt engages with drive pulley 54, which causes drive pulley 54 to rotate. Drive pulley 54 rotates drive shaft assembly 100, and drive shaft assembly 100 rotates phasing gear 56. Then, phasing gear 56 rotates rotors 58, 60.

Supercharger 50 also includes an intake and an outlet for compressed air. As rotors 58, 60 rotate a vacuum is created which draws air in through the intake. The air is then carried along an inner portion of casing 51, compressed, and pushed out through outlet and into the engine.

Referring to FIGS. 3-7 a drive shaft assembly 100 for supercharger 50 is shown according to an exemplary embodiment. Drive shaft assembly 100 has a shaft 102 which extends along a longitudinal axis 104 between drive pulley 54 and phasing gear 56. Shaft 102 is configured to receive an input from drive pulley 54 to rotate shaft 102 around longitudinal axis 104. Shaft 102 extends along and is centered on longitudinal axis 104. Shaft 102 has a first end 106 and a second end 108 located opposite first end 106 along longitudinal axis 104. Second end 108 is positioned within phasing gear 56.

Drive shaft assembly 100 further includes a drive section, shown as first spline coupling or first face spline 110, a driven section, shown as a second spline coupling or second face spline 112, and a spring 114. First face spline 110 is mounted on shaft 102. First face spline 110 is centered on longitudinal axis 104 and positioned between first end 106 and second end 108 of shaft 102. First face spline 110 has a front surface 115 with a plurality of first teeth 116, each individually referred to as a first tooth 116. Plurality of first teeth 116 extend from front surface 115 in a direction away from second end 108. In a specific embodiment, first teeth 116 extend away from front surface 115 in a direction substantially parallel to longitudinal axis 104.

Second face spline 112 is mounted on shaft 102 and is centered on longitudinal axis 104 between first end 106 and second end 108. More specifically, second face spline 112 is located between first end 106 and first face spline 110. In other words, second face spline 112 is located between phasing gear 56 and front surface 115 of first face spline 110. In a specific embodiment, second face spline 112 is fixedly coupled to phasing gear 56 such that second face spline 112 and phasing gear 56 may rotate at the same rate. Second face spline 112 is configured to engage with first face spline 110. In particular, second face spline 112 has a back surface 118 with a plurality of second teeth 120, each individually referred to as a second tooth 120. Plurality of second teeth 120 are configured to engage plurality of first teeth 116 when front surface 115 abuts back surface 118. When first face spline 110 is engaged with second face spline 112, one or more first teeth 116 engage with one or more corresponding second teeth 120. Second teeth 120 extend in a direction away from back surface 118, away from first end 106, and towards first teeth 116. In a specific embodiment, second teeth 120 extend in a direction away from back surface 118 substantially parallel to longitudinal axis 104.

Spring 114 is mounted on shaft 102. Spring 114 has specific properties selected for drive shaft assembly 100, including a spring rate (or spring constant), and a maximum deflection. The maximum deflection is the distance that spring 114 can be compressed under a force without permanent deformation. The spring rate is used to define a spring load, or spring force, of spring 114. The spring load varies with the expansion or compression of spring 114.

Spring 114 is positioned between first face spline 110 and second end 108. Spring 114 includes a first end 122 and a second end 124. First end 122 abuts first face spline 110 and may be coupled to first face spline 110. Spring 114 exerts a spring force against first face spline 110 biasing first face spline 110 into engagement with second face spline 112. More specifically, spring 114 biases first teeth 116 into engagement with second teeth 120.

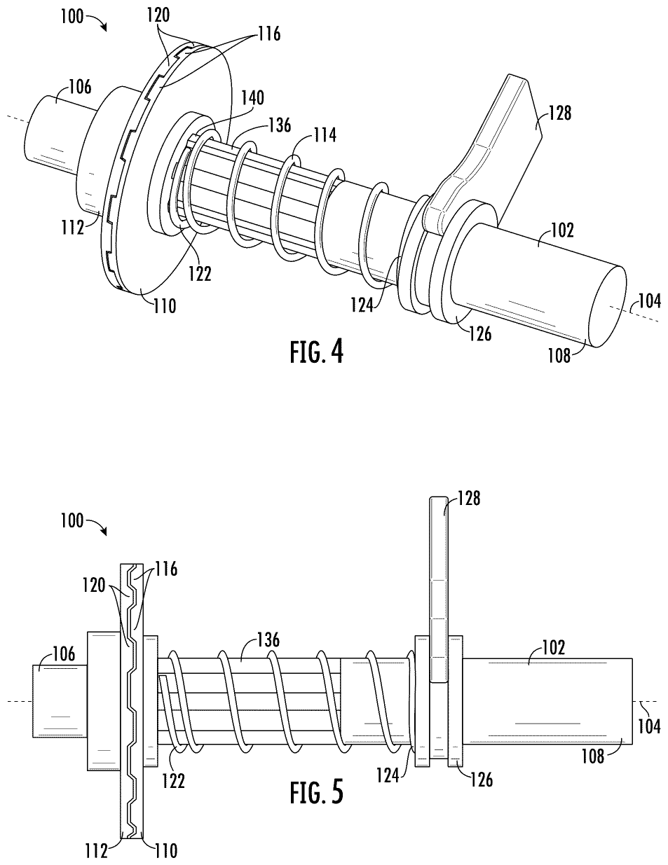

As shown in FIGS. 4 and 5, when first face spline 110 is engaged with second face spline 112, each first tooth 116 is engaged with a corresponding second tooth 120. That is, one or more first teeth 116 are engaged with one or more corresponding second teeth 120. As shown, each first tooth 116 is positioned between two second teeth 120, such that each first tooth 116 engages with one or more corresponding second teeth 120. Specifically, outer side surfaces of each first tooth interface with outer side surfaces of second teeth 120 and a top surface of each first tooth 116 engages with a surface of second face spline 112 positioned between two adjacent second teeth 120. Similarly, one or more second teeth 120 are engaged with one or more corresponding first teeth 116. As shown, each second tooth 120 is positioned between two adjacent first teeth 116, such that each second tooth 120 engages with one or more corresponding first teeth 116. Specifically, outer side surfaces of each second tooth 120 interface with outer side surfaces of first teeth 116 and a top surface of each second tooth 120 engages with a surface of first face spline 110 positioned between two adjacent first teeth 116.

When engaged, first face spline 110 and second face spline 112 rotate around longitudinal axis 104 at the same rate. Spring 114 biases first face spline 110 and second face spline 112 into engagement with each other when the rotational load applied to drive shaft assembly 100 is less than the normal load. More specifically, when a rotational load (or torque) is applied to the first face spline 110, the interface between the plurality of first teeth 116 and the plurality of second teeth 120 transmits the rotational load from first face spline 110 to second face spline 112 such that they rotate around longitudinal axis 104 at the same rate.

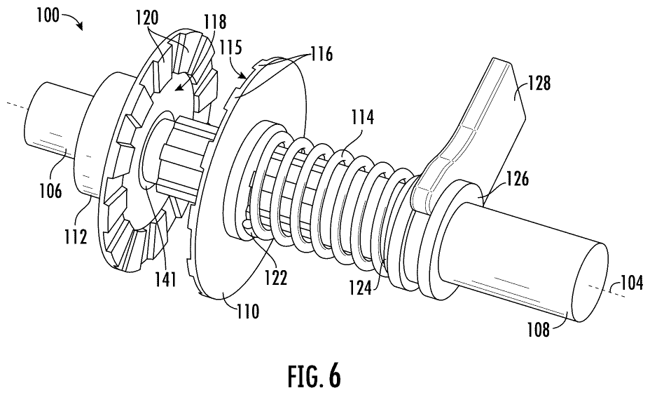

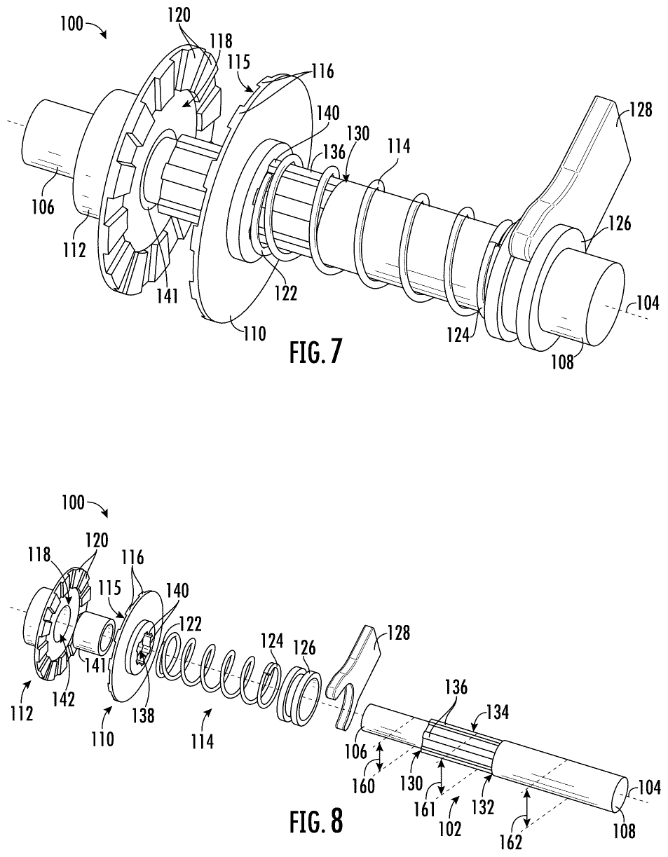

Referring to FIGS. 6 and 7, first face spline 110 and second face spline 112 may be automatically or manually disengaged from each other. As shown in FIG. 6, when the rotational load applied to the first face spline 110 is sufficiently high (i.e., higher than the expected rotational load during normal operation of the engine), the plurality of first teeth 116 push apart from the plurality of second teeth 120. That is, when the rotational load exceeds the frictional force defined between the plurality of first teeth 116 and the plurality of second teeth 120, then the interface between the plurality of first teeth 116 and the plurality of second teeth 120 converts the rotational load into a linear load along longitudinal axis 104 and the linear load compresses spring 114. Specifically, as the frictional force is exceeded, the angled interface between the plurality of first teeth 116 and the plurality of second teeth 120 converts the rotational load into linear movement in a direction along longitudinal axis 104. This linear movement creates a linear load applied along longitudinal axis 104 in a direction opposite the direction the spring force of spring 114, which compresses spring 114.

As spring 114 is compressed, the interface between plurality of first teeth 116 and plurality of second teeth 120 biases first face spline 110 and second face spline 112 apart from each other. As first face spline 110 and second face spline 112 are biased apart, spring 114 is compressed further and first teeth 116 disengage from second teeth 120. In this way, first face spline 110 and second face spline 112 are able to rotate around longitudinal axis 104 at different rates.

As each first tooth 116 slides along each second tooth 120, the pairs of teeth disengage and reduce the rotational load applied to second face spline 112. When disengaged, first face spline 110 rotates with respect to second face spline 112. Thus, each first tooth 116 slidably disengages from its corresponding second tooth 120 and then slides into engagement with an adjacent second tooth 120. This process continues until the linear load along the longitudinal axis is less than the spring force of spring 114. When the linear load is less than the spring load, first face spline 110 reengages with second face spline 112, and each first tooth 116 engages with a corresponding second tooth 120 such that first face spline 110 and second face spline 112 rotated around longitudinal axis 104 at the same rate.

As shown in FIG. 7, first face spline 110 and second face spline 112 may be manually disengaged. To allow for manual disengagement, drive shaft assembly 100 includes a collar 126 and a lever or fork 128. Collar 126 is mounted on shaft 102 between spring 114 and second end 108. Collar 126 is configured to slide along shaft 102 in a direction substantially parallel to longitudinal axis 104. Collar 126 is coupled to second end 124 of spring 114. Fork 128 is coupled to collar 126 and is configured to move collar 126 along shaft 102. When collar 126 moves in a direction towards second end 108 of shaft 102, first face spline 110 disengages from second face spline 112 such that first face spline 110 and second face spline 112 are able to rotate at different rates.

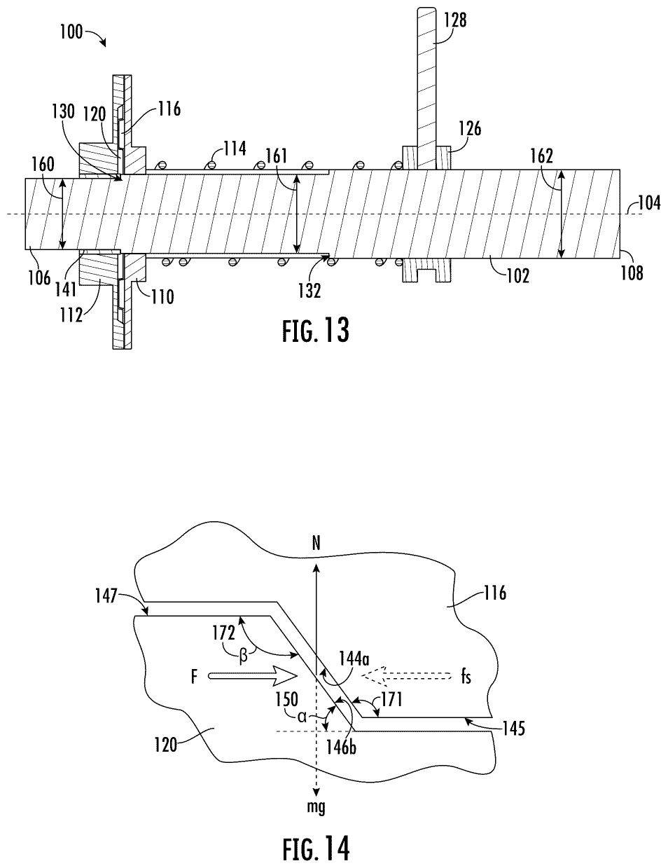

Referring to FIGS. 8-13, shaft 102 includes a first lip 130 and a second lip 132. First lip 130 is located closer the first end 106 of shaft 102 than second lip 132 is located to first end 106. Similarly, second lip 132 is located closer to second end 108 of shaft 102 than first lip 130 is located to second end 108. Second end 124 of spring 114 abuts second lip 132, which helps retain spring 114 on shaft 102. A middle section 134 is located between first end 106 and second end 108 of shaft 102, and more specifically, is located between first lip 130 and second lip 132. As shown, first end 106 has a first width 160 that is less than a second width 161 of middle section 134 and less than a third width 162 of second end 108. Second width 161 is greater than the first width 160 and is less than the third width 162. Third width 162 is greater than first width 160 and greater than second width 161.

Middle section 134 includes ridges 136. Ridges 136 assist in retaining first face spline 110 on shaft 102. The interface between ridges 136 and first face spline 110 allow first face spline 110 and shaft 102 to rotate at the same rate.

Shaft 102 extends through first face spline 110, and more specifically through a central opening 138 in first face spline 110. First face spline 110 is positioned on middle section 134 of shaft 102 and is slidable along middle section 134. As shown, central opening 138 has recesses 140 that are configured to receive ridges 136. Recesses 140 and ridges 136 assist in retaining first face spline 110 along middle section 134. The interface between recesses 140 and ridges 136 causes shaft 102 and first face spline 110 to rotate at the same rate around longitudinal axis 104 when first face spline 110 is mounted on shaft 102.

Shaft 102 also extends through second face spline 112 and, more specifically, through a slip collar 141 positioned within a central opening 142 in second face spline 112. Second face spline 112 is mounted on slip collar 141. Slip collar 141 abuts first lip 130. Together slip collar 141 and first lip 130 assist second face spline 112 in resisting movement along shaft 102 and, more specifically, movement onto middle section 134. Slip collar 141 further assists in the rotation of second face spline 112. In this way, when second face spline 112 is not engaged with first face spline 110, slip collar 141 enables second face spline 112 to rotate independently from first face spline 110 and shaft 102.

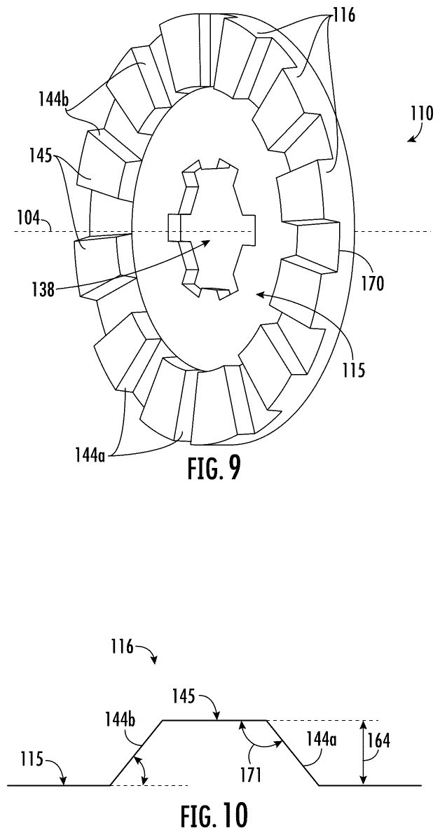

As shown in FIGS. 9 and 10, plurality of first teeth 116 are circumferentially positioned along front surface 115 of first face spline 110. Each first tooth 116 is equally spaced from each adjacent first tooth 116. The space between each first tooth 116 is configured to receive a second tooth 120. Front surface 115 and first teeth 116 define a contact radius. Specifically, the contact radius is defined by the center of front surface 115. More specifically, the contact radius is defined by the distance between an outer edge 170 of front surface 115 and longitudinal axis 104.

Each first tooth 116 has outer surfaces 144 and a top surface 145. Top surface 145 is spaced a distance from front surface 115 and extends along a plane parallel to front surface 115. A first outer surface 144a is located on one side of top surface 145, and a second outer surface 144b is located opposite from first outer surface 144a such that top surface 145 is positioned between first outer surface 144a and second outer surface 144b. Outer surfaces 144a, 144b intersect with top surface 145. Specifically, outer surfaces 144a, 144b intersect with top surface 145 at an angle, such as angle 171. Angle 171 measured between outer surface 144a and top surface 145. Angle 171 is congruent to the angle at which outer surface 144b intersects with top surface 145.

In a certain embodiment, angle 171 is at least 90 degrees. In another certain embodiment, angle 171 is less than or equal to 170 degrees and, more specifically, is less than or equal to 150 degrees. In another certain embodiment, angle 171 is greater than or equal to 100 degrees and, more specifically, is greater than or equal to 120 degrees. In a specific embodiment, angle 171 is between 120 degrees and 150 degrees and, more specifically, is 135 degrees.

Outer surfaces 144 define a plane which radially extends away from longitudinal axis 104. In this way, each first tooth is a trapezoidal shape. As shown, top surface 145 is also a trapezoidal shape and is tapered towards central opening 138 and towards longitudinal axis 104.

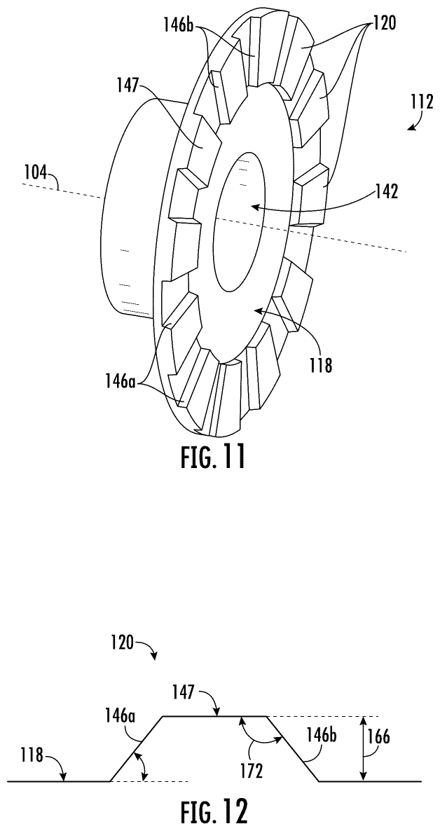

As shown in FIGS. 11 and 12, similar to first face spline 110, plurality of second teeth 120 are circumferentially positioned along back surface 118 of second face spline 112. Each second tooth 120 is equally spaced from each adjacent second tooth 120. The space between each second tooth 120 is configured to receive a first tooth 116.

Second teeth 120 are shaped substantially similar to first teeth 116. Specifically, each second tooth 120 has outer surfaces 146 and a top surface 147. Top surface 147 is spaced a distance from back surface 118 and extends along a plane parallel to a plane defined by back surface 118. Outer surfaces 146 are angled between top surface 147 a back surface 118. A first outer surface 146a is located on one side of top surface 147, and a second outer surface 146b is located opposite from first outer surface 146a such that top surface 147 is positioned between first outer surface 146a and second outer surface 146b. Outer surfaces 146a, 146b intersect with top surface 147. Outer surfaces 146 are skew to longitudinal axis 104. Specifically, outer surfaces 146a, 146b intersect with top surface 147 at an angle, such as angle 172 which is measured between outer surface 146a and top surface 147. Angle 172 is congruent to the angle at which outer surface 146b intersects with top surface 147. Further, angle 172 is congruent to angle 171. As such, outer surfaces 144, 146 have the same angle measurement.

Outer surfaces 146 radially extend away from longitudinal axis 104. In this way, each second tooth is a trapezoidal shape. Additionally, top surface 147 is a trapezoidal shape and is tapered towards central opening 142 and towards longitudinal axis 104.

First teeth 116 interface with second teeth 120 and define a contact angle 150. Specifically, contact angle 150 is the angle at which outer surfaces 144 of first teeth 116 come into contact and abut outer surfaces 146 of second teeth 120. In this way, outer surfaces 144, 146 define a contact angle 150. Contact angle 150 may be measured between the plane defined by the front surface 115 of first face spline 110 and outer surfaces 144. Contact angle 150 may also be measured between the plane defined by the back surface 118 of second face spline 112 and outer surfaces 146. As shown in FIG. 12, contact angle 150, shown as angle α, is measured between second outer surface 146b and back surface 118. Additionally, contact angle 150 is defined as the supplemental angle to angle (β) (i.e., the sum of β and α is 180 degrees). Angle (β), such as angle 171 or angle 172, is measured between an outer surface of a tooth and the top surface of the tooth. As shown in FIG. 12, angle (β) 172 is measured between outer surface 146b and top surface 147.

In a certain embodiment, contact angle 150 is less than 90 degrees. In another certain embodiment, contact angle 150 is greater than or equal to 10 degrees and, more specifically, is greater than or equal to 30 degrees. In another certain embodiment, contact angle 150 is less than or equal to 80 degrees and, more specifically, is less than or equal to 60 degrees. In a specific embodiment, contact angle 150 is between 30 degrees and 60 degrees and, more specifically, is 45 degrees.

Referring to FIGS. 10 and 12, each first tooth 116 has a tooth depth 164 and each second tooth 120 has a tooth depth 166. Tooth depth 164 of first teeth 116 is substantially the same as tooth depth 166 of second teeth 120. Tooth depth 164 of first teeth 116 is defined by the distance between top surface 145 and front surface 115. Tooth depth 166 of second teeth 120 is defined as the distance between top surface 147 and back surface 118. Tooth depths 164, 166 define the amount of deflection required to slidably disengage first teeth 116 from second teeth 120. In a certain embodiment, the maximum deflection of the spring is selected based on tooth depth. In another certain embodiment, tooth depth is selected based on the maximum deflection of the spring.

In a specific embodiment, the tooth depth 164 is greater than or equal to 0.02 inches. In another specific embodiment, tooth depth 164 is less than or equal to 0.04 inches. In another specific embodiment, tooth depth 164 is between 0.02 inches and 0.04 inches and, more specifically, is 0.03125 inches.

In a certain embodiment, plurality of first teeth 116 includes at least 10 teeth, and more specifically includes at least 15 teeth. In another certain embodiment, plurality of second teeth 120 includes at least 10 teeth and, more specifically, at least 15 teeth.

Referring to FIGS. 8-13, spring 114 has specific properties selected for drive shaft assembly 100, including a spring load, a spring rate, and a spring constant. In a specific embodiment, the spring load is selected based on the contact radius of first face spline 110, and more specifically, the spring constant is selected based on the contact radius of the first face spline 110. The relationship between the contact radius of first face spline 110 and the spring load of spring 114 can be represented by the following equation:

$$F = \frac{τ}{r Sin ( α )}$$

In this equation, the spring load (F) of spring 114 is equal to the torque applied to drive shaft assembly 100 divided by contact radius (r) multiplied by the sine of contact angle 150 (α).

In another specific embodiment, the spring rate is selected based on contact angle 150. In a certain embodiment, the spring load is greater than or equal to 200 lbs. and is less than or equal to 350 lbs. and, more specifically, is 250 lbs.

In a certain embodiment, spring 114 is a disc spring with a plurality of discs. Each disc in the plurality of discs has a spring load and a maximum deflection. The number of discs in the plurality of discs is selected based on the tooth depth and the selected spring load. In a specific embodiment, the discs are stacked in a parallel-series arrangement. When discs are stacked in series, the spring load of the disc spring remains constant, but the deflection of the spring is multiplied by the number of discs in series. When discs are stacked in parallel, the deflection of the spring remains constant, but the spring force of the spring is multiplied by the number of discs in parallel.

In a more specific embodiment, the plurality of discs in the disc spring are stacked in a three-series spring stack arrangement and a seven-parallel spring stack arrangement. In a certain embodiment, the discs are stacked in sets of discs, and each set of disc has a specific spring load. In a specific embodiment, there are seven sets of discs. In a specific embodiment, each set of discs has a spring load greater than or equal to 200 lbs. In another specific embodiment, each set of discs has a spring load less than or equal to 350 lbs.

Referring to FIG. 14, a diagram view of a portion of first tooth 116 engaged with a portion of second tooth 120 is shown. More specifically, first outer surface 144a of first tooth 116 is engaged with second outer surface 144b of second tooth 120. This diagram shows the forces acting on first tooth 116 and second tooth 120 when spring 114 biases outer surfaces 144a, 146b into engagement with each other. In order for outer surfaces 144a, 146b to disengage from each other, the spring load of spring 114 must be selected to compress when the drive force exceeds the typical (or the expected) load applied to drive shaft assembly 100 during normal operation of the supercharger. This relationship can be represented by the following equation:

$$F > \frac{{μ}_{s} mg}{Cos ( α ) - {μ}_{s} Sin ( α )}$$

As shown in FIG. 12, N represents the normal force which is equal to the mass of first face spline 110 multiplied by the force exerted by the spring against first face spline 110, F represents the driving force, fₛ represents the static frictional force which, at most, would be the coefficient of friction (μₛ) multiplied by the normal force (N), and α represents contact angle 150.

First face spline 110 and second face spline 112 may be lubricated or unlubricated. First face spline 110 and first teeth 116 are made of a first material. Second face spline 112 and second teeth 120 are made of a second material. In a specific embodiment first material and second material are the same, and more specifically, are hardened steel. The material and the lubrication of first face spline 110 and second face spline 112 may affect the frictional force and the coefficient of friction, which may change the selected spring properties and the required spring load.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles, and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A drive shaft assembly for a supercharger, the drive shaft assembly comprising:
a shaft centered on and extending along a longitudinal axis, the shaft comprising a first end and a second end opposite the first end along the longitudinal axis;
a first spline coupling mounted on the shaft, the first spline coupling comprising a front surface and a plurality of first teeth extending in a direction away from the front surface and away from the second end of the shaft;
a second spline coupling mounted on the shaft and configured to slidably engage with the first spline coupling, the second spline coupling comprising a back surface and a plurality of second teeth extending in a direction away from the back surface and away from the first end of the shaft and towards the first teeth;
a spring mounted on the shaft exerting a spring force against the first spline coupling such that the spring biases the first spline coupling into engagement with the second spline coupling, the spring having a spring constant; and
a contact radius defined by a distance between the longitudinal axis and an outer edge of the front surface of the first spline coupling;
wherein, the spring constant of the spring is selected based on the contact radius;
wherein when the first spline coupling and the second spline coupling are engaged, each first tooth in the plurality of first teeth is engaged with a corresponding second tooth in the plurality of second teeth; and
wherein, when a rotational load applied to the first spline coupling exceeds a frictional force defined between the plurality of first teeth and the plurality of second teeth, then the interface between the plurality of first teeth and the plurality of second teeth converts the rotational load into a linear load along the longitudinal axis, and the linear load compresses the spring such that the first spline coupling slidably disengages from the second spline coupling and each first tooth slidably disengages from its corresponding second tooth.

2. The drive shaft assembly of claim 1, wherein, when the first spline coupling disengages from the second spline coupling, the plurality of first teeth rotates with respect to the plurality of second teeth, and wherein, when the linear load is less than the spring force, the first spline coupling reengages with the second spline coupling and each first tooth engages with a corresponding second tooth.

3. The drive shaft assembly of claim 1, further comprising a collar mounted on the shaft and coupled to the spring, and a lever coupled to the collar, wherein when the collar moves in a direction substantially parallel to the longitudinal axis, the first spline coupling disengages from the second spline coupling.

4. The drive shaft assembly of claim 1, wherein the spring is a disc spring comprising a plurality of discs.

5. The drive shaft assembly of claim 4, wherein the plurality of discs is stacked in sets of discs, wherein each set of discs has a spring load greater than or equal to 200 lbs.

6. The drive shaft assembly of claim 5, wherein each set of discs has a spring load of no more than 350 lbs.

7. A drive shaft assembly for a supercharger, the drive shaft assembly comprising:
a shaft centered on and extending along a longitudinal axis, the shaft comprising a first end and a second end opposite the first end along the longitudinal axis;
a spline coupling mounted on the shaft, the spline coupling comprising:
a first face spline comprising a front surface and a plurality of first teeth extending in a direction away from the front surface and away from the second end of the shaft; and
a second face spline configured to engage with the first face spline, the second face spline comprising back surface and a plurality of second teeth extending in a direction away from the back surface and away from the first end of the shaft and towards the first teeth, the plurality of second teeth configured to slidably engage with the plurality of first teeth;
wherein each first tooth in the plurality of first teeth has a top surface spaced a distance from the front surface, and an outer surface extending between the front surface and the top surface, the outer surface defining a plane that radially extends away from the longitudinal axis;
wherein each outer surface defines a contact angle, the contact angle measured between a plane defined by the front surface and the outer surface; and
a spring mounted on the shaft, the spring exerting a force against the spline coupling such that the spring biases the first face spline into engagement with the second face spline, the spring having a spring rate, wherein the spring rate of the spring is selected based on the contact angle;
wherein, when the first face spline and second face spline are engaged, each first tooth in the plurality of first teeth is engaged with a corresponding second tooth the plurality of second teeth; and
wherein when a rotational load applied to the first face spline exceeds a frictional force defined between the plurality of first teeth and the plurality of second teeth, then the interface between the plurality of first teeth and the plurality of second teeth biases the first face spline and second face spline apart from each other such that the spring compresses allowing the second teeth to slidably disengage from the first teeth.

8. The drive shaft assembly of claim 7, wherein the contact angle is less than 90 degrees.

9. The drive shaft assembly of claim 7, wherein the contact angle is greater than or equal to 30 degrees and is less than or equal to 60 degrees.

10. The drive shaft assembly of claim 7, wherein the spring is a disc spring comprising a plurality of discs.

11. The drive shaft assembly of claim 10, wherein each first tooth in the plurality of first teeth has a depth defined by the distance between the top surface and the front surface, and wherein a number of discs in the plurality of discs is determined based on the depth of the first teeth and a spring load of the spring.

12. The drive shaft assembly of claim 11, wherein the depth is greater than or equal to 0.02 inches and is less than or equal to 0.04 inches.

13. The drive shaft assembly of claim 11, wherein the plurality of discs comprises a 3 series spring stack arrangement.

14. The drive shaft assembly of claim 11, wherein the plurality of discs comprises a 7 parallel spring stack arrangement.

15. A drive shaft assembly for a supercharger, the drive shaft assembly comprising:
a shaft extending along and centered on a longitudinal axis, the shaft comprising a first end and a second end opposite the first end along the longitudinal axis;
a first spline coupling mounted on the shaft, the first spline coupling comprising a front surface and a plurality of first teeth extending from the front surface away from the second end of the shaft in a direction substantially parallel to the longitudinal axis;
a second spline coupling mounted on the shaft and configured to engage with the first spline coupling, the second spline coupling comprising a back surface and a plurality of second teeth extending from the back surface away from the first end of the shaft and towards the first teeth in a direction substantially parallel to the longitudinal axis; and
a spring mounted on the shaft, the spring exerting a force against the first spline coupling such that the spring biases the first spline coupling into engagement with the second spline coupling;
wherein, when a rotational load is applied to the first spline coupling and the first spline coupling and second spline coupling are engaged, the interface between the plurality of first teeth and the plurality of second teeth transmits the rotational load from the first spline coupling to the second spline coupling such that the first spline coupling and the second spline coupling rotate around the longitudinal axis at the same rate;
wherein, when the rotational load is sufficiently high, the interface between the plurality of first teeth and plurality of second teeth biases the first spline coupling and second spline coupling apart from each other, and compresses the spring; and
wherein when the spring is compressed, the plurality of first teeth slidably disengage from the plurality of second teeth such that the first spline coupling and the second spline coupling are able to rotate around the longitudinal axis at different rates.

16. The drive shaft assembly of claim 15, wherein the first spline coupling is centered on the longitudinal axis and second spline coupling is centered on the longitudinal axis, wherein each first tooth of the plurality of first teeth is equally spaced from each other and radially positioned around the longitudinal axis, and wherein each second tooth in plurality of second teeth is equally spaced from each other and radially positioned around the longitudinal axis.

17. The drive shaft assembly of claim 15, wherein the plurality of first teeth comprises at least 10 teeth, and wherein the plurality of second teeth comprises at least 10 teeth.

18. The drive shaft assembly of claim 15, further comprising a collar mounted on the shaft and coupled to the spring, and a lever coupled to the collar, wherein when the collar moves in a direction substantially parallel to the longitudinal axis, the first spline coupling disengages from the second spline coupling.

19. The drive shaft assembly of claim 15, wherein the plurality of first teeth is made from a first material and the plurality of second teeth are made from a second material, and wherein the first material and the second material are the same.

20. The drive shaft assembly of claim 19, wherein the first material and the second material are hardened steel.
